(19) United States
(12) Patent Application Publication
(10) Pub. No.: US 2006/0014520 A1
(43) Pub. Date: Jan. 19, 2006

(54) Method and system for supporting guest services provided by a wireless LAN

(76) Inventors: Eric C. Anderson, Gardnerville, NV (US); Robert P. Morris, Raleigh, NC (US)

Correspondence Address: IPAC, 111 Corning Road, Suite 220, Cary, NC, 27511, US

(21) Appl. No.: 10/893,806

(22) Filed: Jul. 19, 2004

(51) Int. Cl. H04Q 7/38; H04M 11/00

(52) U.S. Cl. 455/408; 455/414.1

(57) ABSTRACT

In a first aspect, the present invention is a method that includes establishing a relationship between a mobile device and a service, utilizing the service to authorize a guest relationship between the mobile device and a wireless network with which the mobile device has no preexisting relationship, and in response to receiving authorization from the service, utilizing the services provided by the wireless network. Through aspects of the present invention, the mobile device is permitted to access the wireless network as a guest without requiring additional manual intervention from a user of the mobile device. In a second aspect, the present invention is a system that includes a wireless network, a device enabled to engage in wireless communications, and a service coupled to the network via a public network. According to the second aspect, a relationship between the service and the device is established so that the service can be utilized by the device to authorize a guest relationship between the device and the wireless network, thereby allowing the device to access the wireless network as a guest without requiring additional manual intervention from a user of the mobile device.

### FIELD OF INVENTION

The present invention relates to wireless mobile electronic devices, and more particularly to supporting guest services provided by a wireless local area network.

### BACKGROUND OF THE INVENTION

A wireless LAN is a local area network that transmits over the air and does not require a line site between a sending and receiving device. Typically, one or more wireless base stations, which are also referred to as access points, are wired to an Ethernet network, while wireless adapters are either built into or attached to client devices. The access points and the wireless devices communicate via radio frequency over an area of several hundred feet through walls and other barriers. If there are multiple access points as in a corporation, for example, then roaming devices can be handed-off from one access point to another. One example of a wireless LAN standard today is 802.11.

For short distances between two devices, a wireless personal area network (PAN) may be used, such as Bluetooth. Bluetooth is an open standard for short-range transmission of digital voice and data between local devices, such as laptops, PDAs, imaging devices, phones, and desktop devices. Bluetooth supports point-to-point and multi-point applications, and has a range of up to 10-meters without a power boost and up to 100 meters with a power boost. Infrared transmission (IrDA) may also be used for very short distances between two devices, however, IrDA requires line of site between the two devices. The Bluetooth protocol uses non-directional radio waves that can transmit through walls and other barriers.

Many mobile handheld electronic devices, such as cameras, PDAs, laptops and mobile phones, are equipped with wireless technology, and are able to take advantage of the services offered by a wireless LAN via a PAN. For example, Bluetooth-enabled camcorders are now available. Accordingly, these devices allow a user to gain access to resources offered by the wireless LAN, e.g., access to the Internet, and because the devices are mobile, they can be used when the user travels on business or for vacation.

Typically, a wireless LAN charges a fee for allowing a wireless device to access its network. Accordingly, a billing relationship is established between the wireless device and the wireless LAN before the device can access the network. Establishing such a relationship can be tedious and time consuming. For example, before a device can access a wireless LAN, the user of the device generally must manually configure the device to enable the device to communicate with the network, and agree to pay a fee for services. The user must provide billing information and other personal data in order to register the device with a network provider. This particular task can be especially onerous when the wireless device is one that is not suited for data entry, such as a digital camera or PDA.

When a user carries his or her wireless device from place to place and encounters a wireless network with which the device does not have a preexisting relationship, the user must establish a guest relationship with the network before he or she can use the device to access the network. Nevertheless, because establishing this relationship is so tedious and time consuming, the user oftentimes chooses not to utilize the device unless access is absolutely necessary.

Moreover, depending on the service provided, the fee for guest access to a network should be small. For example, access to the Internet to download one's electronic mail should be relatively inexpensive because the amount of data downloaded can be small and the time to download can be short. Nevertheless, the cost for a network provider to track, bill and collect such small fees can exceed the actual amount due from the user. Thus, in order to make such services cost effective, network providers often charge excessive fees, which then discourages users from utilizing their mobile devices.

Accordingly, what is needed is an improved system and method for supporting guest services provided by a wireless LAN. The system and method should allow a user of a wireless electronic device to access a wireless network as a guest with little or no user intervention. The system and method should also simplify the billing and collection process for the network provider such that providing such guest services is cost effective. The present invention addresses such a need.

### SUMMARY OF THE INVENTION

The present invention is directed to a method and system for supporting guest services provided by a wireless LAN. In a first aspect, the present invention is a method that includes establishing a relationship between a mobile device and a service, utilizing the service to authorize a guest relationship between the mobile device and a wireless network with which the mobile device has no preexisting relationship, and in response to receiving authorization from the service, utilizing the services provided by the wireless network. Through aspects of the present invention, the mobile device is permitted to access the wireless network as a guest without requiring additional manual intervention from a user of the mobile device.

In a second aspect, the present invention is a system that includes a wireless network, a device enabled to engage in wireless communications, and a service coupled to the wireless network via a public network. According to the second aspect, a relationship between the service and the device is established so that the service can be utilized by the device to authorize a guest relationship between the device and the wireless network, thereby allowing the device to access the wireless network as a guest without requiring additional manual intervention from a user of the mobile device.

The method and system of the present invention allows a user of the wireless electronic device to access a wireless LAN as a guest without having to enter manually additional information related to billing and the like. Moreover, the billing and collection process is simplified so that the user is encouraged to utilize his or her device wherever a wireless network is available, and the network is encouraged to offer guest services.

### BRIEF DESCRIPTION OF THE DRAWINGS

FIG. 1 is a block diagram illustrating a network configuration for use in accordance with a preferred embodiment of the present invention.

FIG. 2 is a flowchart illustrating the process for establishing a relationship between the service and the device or the network according to a preferred embodiment of the present invention.

FIG. 3 a flow diagram illustrating the process for establishing guest services according to a preferred embodiment of the present invention.

FIG. 4 is a flow diagram illustrating the process for automatically billing for guest services provided to a device by a plurality of wireless networks according to a preferred embodiment of the present invention.

FIG. 5 is a flow diagram illustrating the process for automatically billing for guest services provided by a wireless network to a plurality of devices according to a preferred embodiment of the present invention.

### DETAILED DESCRIPTION OF THE INVENTION

The present invention relates to wireless mobile electronic devices, and more particularly to managing guest services provided by a wireless local area network. The following description is presented to enable one of ordinary skill in the art to make and use the invention and is provided in the context of a patent application and its requirements. Various modifications to the preferred embodiments and the generic principles and features described herein will be readily apparent to those skilled in the art. For example, while the preferred embodiment is implemented in a handheld electronic device, those skilled in the art would appreciate that any electronic device having access to a wireless network, or even a wired network, would suffice. Thus, the present invention is not intended to be limited to the embodiments shown, but is to be accorded the widest scope consistent with the principles and features described herein.

According to a preferred embodiment of the present invention, services provided by a billing service simplify a guest registration process and a user payment process. Thus, the user is encouraged to use his or her wireless device anywhere there is a wireless network. Moreover, a billing and collection process for the network is simplified, thereby encouraging the network to offer reasonable fees for guest services.

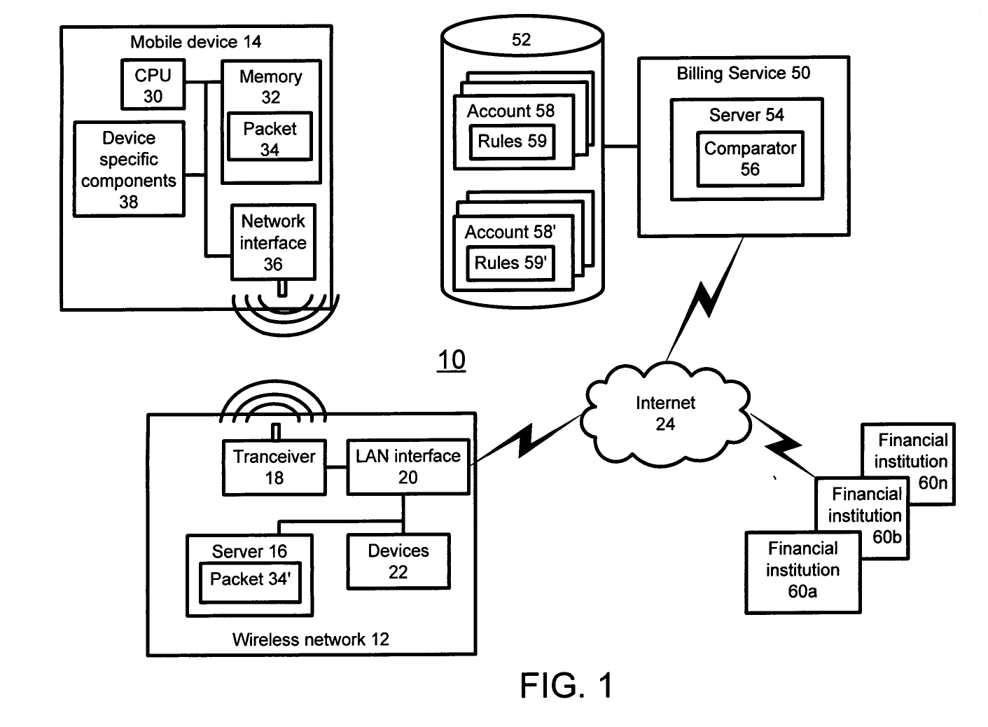

FIG. 1 is a block diagram illustrating a network configuration for use in accordance with the preferred embodiments of the present invention. In a preferred embodiment, the network configuration 10 comprises a wireless network 12 capable of wireless communication with a wireless mobile device 14. The network 12 includes one or more base stations, typically a server 16, coupled to one or more access points (transceivers) 18 through a LAN interface (e.g., Ethernet hub) 20. Other stationary devices 22, such as a printer, fax machine, music jukebox, and the like, may also be coupled to the LAN interface 20 over a wired LAN. The LAN interface 20 provides all the devices within the network access to the Internet 24. Each mobile device 14 includes a CPU or DSP 30, non-volatile memory 32, a network interface 36 that enables wireless communication, and device specific components 38 for carrying out the intended function of the device 14.

In a preferred embodiment, the non-volatile memory 32 is a non-removable memory that is extremely difficult, if not impossible, to extract from the unit. In the preferred embodiment, the non-volatile memory 32 may reside on a system core ASIC, where the ASIC can be a controlled device (available only via warranty service) not readily available on the market or easily replicated. In addition, both the device 14 and the network 12 are provided at appropriate points with respective private/public key pairs and/or secret keys as part of the process of establishing a secure connection, for encrypting some, if not all, of the transmissions between the device 14 and the network 12. The method for establishing a secure connection between devices is well known and will not be described herein.

Currently, if the device 14 is within the operating area of the network 12, and the device 14 does not have a preexisting relationship with the network 12, the user of the device is required to provide personal and/or billing information, i.e., name, billing address, form of payment, etc., to the network 12 before access is granted to the network 12. As stated above, this task is time consuming and particularly burdensome if the device 14 is one that does not accommodate easy data entry features.

The present invention eliminates the need for the user to perform manual steps to allow the user's mobile device 14 to access the wireless network 12 as a guest device 14. According to the preferred embodiment of the present invention, a billing service 50 is provided that automatically sets up and manages a guest relationship between the device 14 and the network 12. The billing service 50 includes a server 54 coupled to a database 52. The service 50 creates and stores an account 58 associated with the device 14. Each account 58 includes information related to the associated device 14, e.g., the name of the device's user and related billing information, that is typically required to establish a guest relationship with a network 12.

In addition, in a preferred embodiment, the account 58 includes a set of rules 59, which dictate the terms and conditions under which the user of the device 14 is willing to establish a guest relationship. The rules 59 include, at a minimum, finance rules that define what the user is willing to pay for services offered by the network 12, such as the maximum dollar amount for downloading a certain number of bytes, i.e., cents per megabyte, or the maximum dollar amount for browsing, i.e., cents per minute, or the maximum dollar amount for a level of bandwidth for a specified period of time, or the cost for printing pages/images, i.e., cents per page/image. In addition, the rules 59 can include other types of rules, such as data-centric or traffic-centric rules, i.e., rules that define the type and amount of traffic exchanged, or security rules, i.e., rules that define minimum security and privacy requirements such as a firewall.

In the preferred embodiment, the wireless network 12 also establishes a relationship with the billing service 50, which creates and stores an account 58′ associated with the network 12. The account 58′ includes information related to the network 12 and rules 59′ that define the network's 12 pricing for its services. If the network 12 does not have an account with the service 50, the network 12 should provide appropriate account information to the service 50 on the fly, although, in principle, the service 50 could provide billing information to the unregistered network 12. The later, however, presents serious security issues. Accordingly, because either process can be cumbersome and can potentially pose a security issue, a relationship between the network 12 and the service 50 is preferable.

In operation, when the device 14 encounters the network 12 and issues a request to access the network 12 as a guest, the request is forwarded to the billing service 50 over a secure connection. The service 50 uses the information in the associated accounts 58, 58′ to set up the guest relationship between the device 14 and the network 12. The billing service 50 utilizes a comparator 56 to compare the network's 12 prices 59′ to the device's rules 59. If none of the rules 59 are violated, the service 50 automatically authorizes the guest relationship. Accordingly, the device 14 can access the network 12 immediately without requiring the user to manually submit additional information to establish the guest relationship.

In a preferred embodiment, after the device 14 has completed its transaction and terminated its guest relationship with the network 12, the billing service 50 automatically processes the fee for services rendered. For the device 14, the billing service 50 preferably creates a list that includes all fees incurred by the device 14 during a predetermined time period, e.g., a month. For the network 12, the billing service 50 creates another list that includes all fees charged by the network 12 during the predetermined time period.

At the end of the predetermined time period, the billing service 50 totals the fees on the device's list and bills the user for the total fees. The service 50 also totals the fees on the network's list and credits the network 12 for the total fees. In a preferred embodiment, the billing service 50 is authorized to deduct automatically the total fee from the user's financial institution 60a or to charge the total fee to the user's credit card, and to credit automatically the total fee to the network's financial institution 60b.

In this manner, the payment and billing process is simplified for the user and for the network 12. Because the user makes or authorizes one payment, the user is spared the nuisance of paying a multitude of invoices for small dollar amounts to networks 12 that have provided guest services. Similarly, the network 12 receives one payment and avoids the nuisance of generating invoices to a multitude of users for small dollar amounts.

In the preferred embodiment, the service 50 is provided by a third party vendor. The service 50 charges a nominal fee to the device 14 and to the network 12 for its services. In another embodiment, the service 50 is provided by a user's home server, which is a private server owned by the user. In this embodiment, the advantages are enjoyed mostly by the user, although the network 12 can bill the home server directly.

According to the preferred embodiment of the present invention, the services provided by the billing service 50 simplify the guest registration process and the user payment process. Thus, the user is encouraged to use his or her device 14 anywhere there is a wireless network 12. Moreover, the billing and collection process for the network 12 is simplified, thereby encouraging the network 12 to offer reasonable fees for guest services.

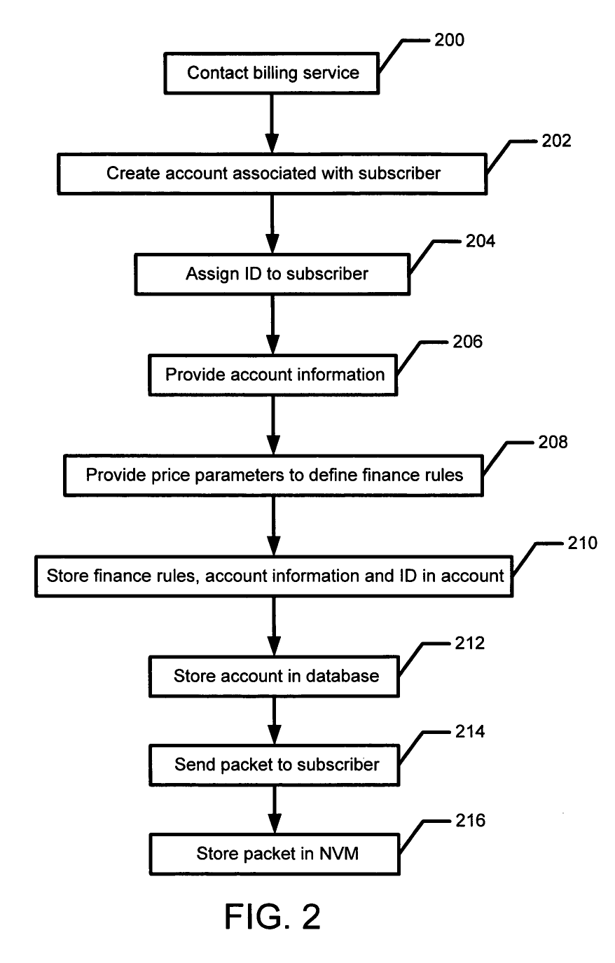

FIG. 2 is a flowchart illustrating the process for establishing a relationship between the service 50 and the device 14 or the network 12 according to a preferred embodiment of the present invention. Referring to FIG. 1 and FIG. 2, the process begins when the device 14 or network 12 (referred to generally as the subscriber) contacts the billing service 50 (step 200), preferably via the Internet 24, to subscribe with the service 50. Alternatively, the registration process can be performed via telephone or facsimile. Next, the billing service 50 creates an account 58, 58′ for the subscriber (step 202). The subscriber is assigned an identifier (step 204) that uniquely identifies the subscriber as a member of the service 50. For security reasons, the identifier does not identify the subscriber's account or the subscriber's identity.

Next, a user of the device 14 or a network 12 administrator provides account information to the service 50 (step 206). Preferably, account information includes an address, contact information and billing data. The billing data includes one or more financial institutions 60a, 60b, e.g., banks or credit cards, from and to which funds can be transferred. The user or the network administrator also provides pricing parameters to define rules 59 governing a guest relationship (step 208). Preferably, for the user account, device information is also provided including, the device's serial number, manufacturer, and model. For the network account, any identifying information, e.g., IP address, is included. This additional information assists in preventing fraud.

Preferably, the service 50 provides a set of pricing options and allows the user of the device 14 to enter the amount of money he or she is willing to pay for various network services. Alternatively, if the user does not enter such values, the service 50 provides default values. In addition, the service 50 allows the user to limit the total amount of billed service for a specified time period, e.g., one month. For the network 12, the service 50 also presents the set of pricing options and allows the network administrator to enter the prices for its guest services. Other types of “rules” can be offered by the service 50 in order to provide additional functionality for the subscribers. For example, the service 50 can allow the user to define rules pertaining to the type of data downloaded onto the device 14, e.g., only text messages and no attachments, or rules pertaining to a limit on the size of an attachment, e.g., no attachments larger than 50 k.

Once the subscriber has been assigned the identifier, has provided the account information and has defined the rules 59, 59′, the service 50 stores this data in the associated account 58, 58′ (step 210). The account 58, 58′ is then stored in the database 52 (step 212), and utilized to manage guest relationships for the subscribed network 12 and/or the device 14. Finally, the service 50 transmits back to the subscriber a packet 34, 34′ that includes an identifier for the service 50 (“service ID”), and the subscriber's identifier (step 214). The subscriber 12, 14 then stores the packet 34, 34′ in non-volatile memory 32 (step 216). The packet 34, 34′ is used thereafter to facilitate guest relationships, as will be described below.

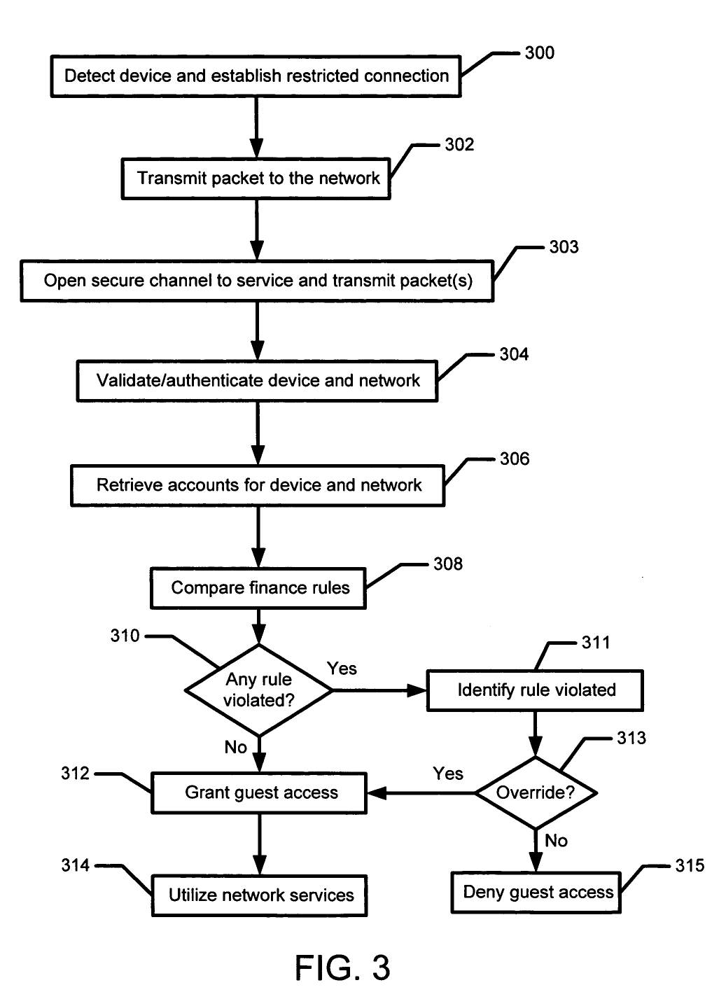

Once the relationship between the service 50 and the device 14 and the network 12 has been established, the service 50 can be utilized to setup and manage guest relationships. FIG. 3 a flow diagram illustrating the process for establishing guest services according to a preferred embodiment of the present invention. The process begins when the network server 16 detects the presence of a device 14 within the active area of the wireless network 12 using a network protocol discovery process and establishes a restricted connection (step 300). In the preferred embodiment, this is a secure connection. Once the network server 16 detects the presence of the device 14, the server 16 asks the device 14 whether it wishes to access the network 12. In response to receiving the request, the device 14 transmits the packet 34 to the network server 16 (step 302). Alternatively, the device 14 transmits the packet 34 automatically to the network server 16 once the device 14 detects the network 12.

In the preferred embodiment, the exchange between the device 14 and the network server 16 is over a secure connection. The device packet 34 is transmitted in an encrypted message that changes over time. Randomizing the message in this manner ensures that a hacker cannot simply “sniff” an encrypted value and reproduce it to impersonate an authorized device.

As stated above, the packet 34 includes the identifier for the service 50 and the identifier identifying the device 14 as a member of the service 50. The packet 34 also preferably includes a URL for the service's server 54, which is not encrypted so that the network server 16 can interpret the URL. Once the network server 16 receives the encrypted packet 34 and unencrypted URL from the device 14, it opens a secure communication channel, e.g., a VPN, between the service 50 and the device 14 and the packet 34 is then transmitted to the service's server 54 (step 303). When the service 50 receives the device's packet 34, the service 50 transmits a request to the network 12 for the network's packet 34.′ Preferably, the network server 16 opens a second secure communication channel to the service 50 and transmits the network's packet 34′ over the secure channel to the service 50 so that the service 50 receives both packets 34, 34′.

Once the service 50 receives the packets 34, 34′ from the device 14 and the network 12, the service 50 validates and/or authenticates the device 14 and the network 12 (step 304). This process can include requesting a username and password, a PIN, or some other mode of authentication. Note that authentication is needed to ensure that the user of the device 14 is the authorized user, i.e., the rightful owner. Naturally, if the device 14 itself requires user authentication prior to use, the authenticating step adds extra security, or the additional authentication step could be eliminated. Once the device 14 and network 12 are validated, the service 50 retrieves from the database 52 the device's 14 account 58 and the network's 12 account 58′ (step 306). The service 50 then compares the device's rules 59 to the network's rules 59′ to determine whether the guest relationship should be authorized (step 308).

In a preferred embodiment, the device 14 specifies in the packet 34 the type of service it wants to utilize from the network 12, e.g., downloading email. The service 50 then compares the device's rules 59 and the network's rules 59′ pertaining to the desired service, e.g., email, rather than comparing all of the rules 59, 59.′ If the device 14 does not make such a specification, then all of the rules 59, 59′ are compared.

If the device's rules 59 are not violated (step 310), e.g., the price of guest service is within the user's designated price range(s), then the service 50 transmits a message to the network 12 and to the device 14 indicating that guest access is granted (step 312). The device 14 is then permitted to utilize the network 12 as a guest (step 314). In an alternate embodiment, the network 12, having negotiated for payment successfully with the service 50, will simply grant access to the device 14.

If one or more of the device's rules 59 are violated (step 310), i.e., one or more of the network's price parameters exceeds a corresponding price parameter designated by the device 14, then the service 50 notifies the network 12 and the device 14 of the rule(s) violated (step 311). In a preferred embodiment, the service 50 allows the user of the device 14 to override one or more of the rule(s) violated. For example, the user might override a violated rule if the user must access the network 12 and no other network services are available in the area, or if the user is interested in utilizing one type of service and not others. If the user overrides one or more of the violated rule(s) (step 313), then the service 50 transmits a message to the network 12 and to the device 14 indicating that guest access is authorized (step 312) for specific services, and the device 14 is then permitted to utilize the network 12 as a guest (step 314) for those services. Otherwise, if the user chooses not to override (step 313), the service 50 transmits a message to the network 12 and to the device 14 indicating that guest access is denied (step 315).

Once the device 14 is permitted to utilize the network 12, various services are available, such as browsing, downloading files, accessing electronic mail, and printing documents or images, depending on what the device 14 has agreed to pay for. Note that the device 14 can transmit to the service 50 more than one packet 34 during a guest session with the network 12, where each packet 34 includes a request to utilize a different service offered by the network 12. At the conclusion of the guest session between the device 14 and the network 12, the network 12 tallies the fee for each service provided and charges the device 14. Alternatively, if the device 14 is utilizing multiple services, the network 12 can charge the device 14 incrementally or after each transaction/service. As part of its management duties, the service 50 automatically processes the fee(s) charged by the network 12 so that the billing and payment process is simplified for both the user of the device 14 and the network 12.

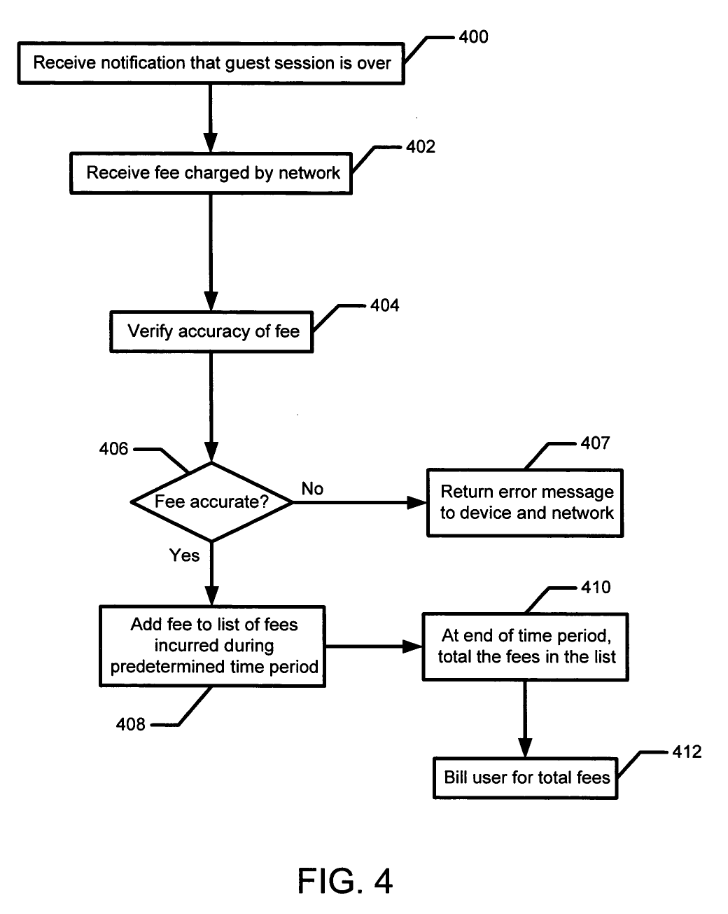

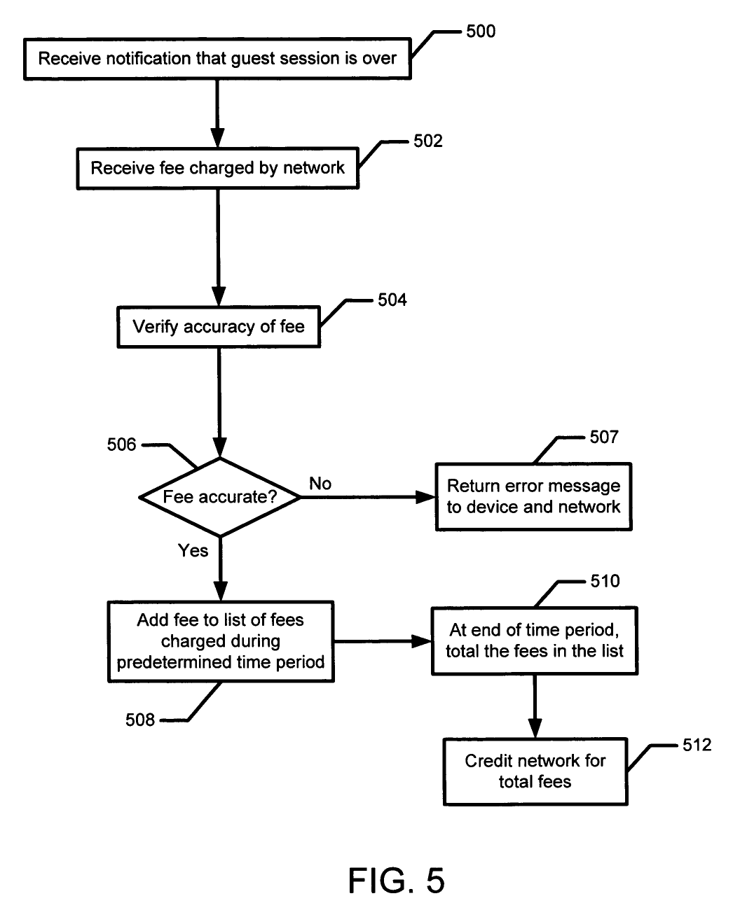

FIG. 4 is a flow diagram illustrating the process for automatically billing for guest services provided to a device 14 by a plurality of wireless networks 12, and FIG. 5 is a flow diagram illustrating the process for automatically billing for guest services provided by a wireless network 12 to a plurality of devices 14 according to a preferred embodiment of the present invention. Referring first to FIG. 4, the process focuses on the billing process for the device 14 that has procured guest services from a plurality of wireless networks 12 over a predetermined period of time, e.g., one month. The process begins when the service 50 receives notification that the guest session (or transaction) has ended (step 400). The service 50 can receive the notification either from the device 14 or from the network 12, or both. Once the session (or transaction) has ended, the service 50 receives a fee charged by the network 12 for guest services provided to the device 14 (step 402).

The service 50 then verifies the accuracy of the fee charged (step 404). In a preferred embodiment, the service 50 collects a use record from the device 14 and from the network 12. The use record details what services were utilized by the device 14 or provided by the network 12. For example, the use record includes, depending on the service used or provided, the amount of time spent browsing the Internet, the number of bytes downloaded, the number of images or documents printed, etc. After the service 50 collects the use record from the device 14 and from the network 12, the service 50 compares the use records to determine if any discrepancies exist. If one or more discrepancies exist, the fee charged is not accurate (step 406) and an error message is returned to the device 14 and to the network 12 (step 407). The error message preferably requests that both parties resolve the billing discrepancy.

If no discrepancies exist, and the fee charged corresponds to the service(s) provided, then the fee is accurate (step 406). Thereafter, the service 50 adds the fee to a list that includes all fees incurred for guest services provided by the current and other wireless networks 12 during a predetermined period of time (step 408). The predetermined period of time is preferably a two week period or a month.

At the end of the predetermined time period, the service 50 totals the fees incurred in the list (step 410) and bills the user of the device for the total amount of fees incurred during the predetermined time period (step 412). In a preferred embodiment, when the user establishes the relationship with the service 50 prior to using the service 50, the user designates a financial institution 60a from which funds may be withdrawn. The service 50 then automatically debits the total amount of fees from the designated financial institution 60a, preferably with prior authorization from the user.

Referring now to FIG. 5, the process illustrated here focuses on the billing process for the network 12 that has provided guest services to a plurality of wireless devices 14 over a predetermined period of time, e.g., one month. The process is similar to that illustrated in FIG. 4. That is, the process begins when the service 50 is notified that guest session (or transaction) is over (step 500) and the service 50 receives the fee charged (step 502). The service 50 verifies the accuracy of the fee (step 504), and returns an error message if the fee is not accurate (steps 506 and 507).

If no discrepancies exist, and the fee charged corresponds to the service(s) provided, then the fee is accurate (step 506). Thereafter, the service 50 adds the fee to a list that includes all fees charged for guest services provided to the current device 14 and other devices 14 during the predetermined period of time (step 508).

At the end of the predetermined time period, the service 50 totals the fees charged in the list (step 510) and credits the network for the total amount of fees charged during the predetermined time period (step 512). In a preferred embodiment, when the network establishes the relationship with the service 50 prior to using the service 50, the network 12 designates a financial institution 60b into which funds may be transferred. The service 50 then automatically credits the total amount of fees charged to the designated financial institution 60a after authorization from a network administrator.

By aggregating the fees incurred for guest services provided by the plurality of wireless networks 12 over the predetermined time period and billing the user for a lump sum amount, the service 50 significantly simplifies the payment process for the user. The user avoids the nuisance of handling multiple invoices from multiple networks for relatively small fees that are due at varying times. Accordingly, the user is more inclined to utilize the device 14 wherever a wireless network 12 is available.

Similarly, aggregating the fees charged for guest services provided by the wireless network 12 to a plurality of devices 14 over the predetermined time period and crediting the network 12 for a lump sum amount significantly simplifies the billing process for the network 12. The network 12 avoids the nuisance of preparing and collecting multiple invoices to multiple users for relatively small fees that are due at varying times. Accordingly, the billing process is more cost effective and the network 12 is more inclined to offer guest services at a reasonable price.

Through aspects of the present invention, a temporary guest relationship between a device 14 and a local network 12 is securely established without requiring the network 12 or the device 14 to provide private information to one another. The only information exchanged is the minimum required identifier, e.g., the service URL. All other communications required to establish the temporary guest relationship that contain any private information, e.g., account numbers, names, etc., are transferred via secure communications between the device 14 and service 50, and separately between the network 12 and service 50. By establishing separate secure communication channels, the device 14 is isolated from the network 12, and vice versa. Thus, the service 50 provides security for both the network 12 and the device 14 user for the purpose of setting up a temporary guest relationship through the service 50.

Accordingly, services provided by the billing service 50 significantly simplify the process for establishing a guest relationship between the network 12 and the device 14 and the billing and payment process. Thus, the user is encouraged to use his or her wireless device 14 anywhere there is a wireless network 12, and the network 12 is encouraged to offer reasonable fees for guest services.

A method and system for supporting guest services provided by a wireless network to a mobile electronic device has been disclosed. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for supporting guest services provided by a wireless network to a mobile electronic device comprising;
establishing a relationship between the mobile device and a service;
utilizing the service to authorize a guest relationship between the mobile device and the wireless network, wherein the mobile device has no preexisting relationship with the wireless network; and
in response to receiving authorization from the service, utilizing the services provided by the wireless network, whereby the mobile device is permitted to access the wireless network as a guest without requiring additional manual intervention from a user of the mobile device.

2. The method of claim 1 wherein establishing a relationship includes creating an account associated with the mobile device and storing the user's billing information in the account.

3. The method of claim 1 wherein establishing a relationship includes creating an account associated with the mobile device and storing a plurality of rules in the account.

4. The method of claim 3, wherein establishing the relationship includes defining rules that indicate how much money the user is willing to pay for services provided by the wireless network.

5. The method of claim 4, wherein defining rules includes allowing the user to set price parameters.

6. The method of claim 4, wherein defining rules includes setting default price parameters.

7. The method of claim 4 further comprising:
transmitting to the service a packet from the mobile device when the mobile device encounters the wireless network and wishes to access the wireless network.

8. The method of claim 7, wherein utilizing the service to authorize the guest relationship includes:
in response to receiving the packet, comparing the rules associated with the mobile device with price parameters designated by the wireless network; and
based on the comparison, determining whether any one of the rules is violated.

9. The method of claim 8 wherein utilizing the service to authorize the guest relationship further includes authorizing the relationship if none of the rules is violated.

10. The method of claim 8, wherein utilizing the service to authorize the guest relationship further includes denying authorization if any one of the rules is violated.

11. The method of claim 10 further comprising:
in response to receiving a denial from the service, allowing the user of the mobile device to override the denial and to utilize the services.

12. The method of claim 1 further comprising:
processing by the service a fee charged by the wireless network for the services provided to the mobile device.

13. The method of claim 12, wherein processing the fee includes verifying that the fee charged corresponds to the services provided to the mobile device.

14. The method of claim 12, wherein processing the fee includes adding the fee to a list including fees incurred by the mobile device over a predetermined time period.

15. The method of claim 14 further comprising at an end of the predetermined time period, totaling the fees in the list and billing the user for the total fees.

16. The method of claim 12 further including establishing a relationship between the wireless network and the service by creating an account for the wireless network.

17. The method of claim 16, wherein processing the fee includes adding the fee to a list including fees charged over a predetermined time period.

18. The method of claim 17 further comprising, at an end of the predetermined time period, totaling the fees in the list and crediting the wireless network for the total fees charged.

19. A method for establishing a guest relationship between a mobile device and a wireless network comprising:
providing a service for collecting and storing account information related to the mobile device; and
authorizing by the service the guest relationship between the mobile device and the wireless network based on the account information, wherein the mobile device is granted guest access to the wireless network without requiring a user of the mobile device to provide account information to the wireless network.

20. The method of claim 19, wherein providing the service includes coupling a server associated with the service to a public network.

21. The method of claim 19 further including allowing a user of the mobile device to provide the account information, wherein the account information includes a plurality of rules some of which indicate how much money the user is willing to pay for guest services.

22. The method of claim 21, wherein authorizing the guest relationship includes comparing the rules with fees charged by the wireless network, wherein if the fees charged satisfy the rules, the service authorizes guest access by the mobile device.

23. The method of claim 22 further including denying guest access by the mobile device if the fees charged violate any one of the rules.

24. The method of claim 23 further including if guest access is denied, allowing the user to override at least one of the violated finance rules so that guest access can be granted.

25. The method of claim 22 further including collecting and storing account information related to the wireless network by the service, wherein the account information includes fees charged by the wireless network for guest services.

26. The method of claim 25 further including receiving by the service over a secure communication channel a packet from the mobile device requesting guest access to the wireless network and, after authenticating the mobile device, retrieving the account information related to the mobile device and the account information related to the wireless network.

27. The method of claim 19 further including monitoring the guest relationship to prevent fraudulent billing by the wireless network.

28. A method for automatically billing for guest services provided to a mobile device by a plurality of wireless networks comprising:
providing a service for collecting and storing account information related to the mobile device;
establishing by the service a plurality of guest relationships between the mobile device and the plurality of wireless networks;
receiving by the service a fee charged by each of the plurality of wireless networks for the guest services provided to the mobile device; and
automatically processing each fee for the mobile device such that a user of the mobile device is not required to provide payment to each of the plurality of wireless networks.

29. The method of claim 28, wherein processing each fee includes verifying at the time the services are provided that the fee charged corresponds accurately to the services provided.

30. The method of claim 29, wherein verifying the fee includes collecting use records from the mobile device and the wireless network and comparing the records to ensure that the records match.

31. The method of claim 30 further including:
if the use records do not match, sending an error message to the mobile device and to the wireless network that transmitted the fee charged, and requesting resolution.

32. The method of claim 28, wherein processing each fee includes totaling each of the fees charged during a predetermined time period and billing the user for the total fee at the close of the predetermined time period.

33. The method of claim 32 further including requiring the user to provide the account information, wherein the account information includes a financial institution associated with the user.

34. The method of claim 33 further including automatically debiting the total fee from the user's financial institution after authorization from the user at the close of the predetermined time period.

35. A method for automatically collecting fees for guest services provided by a wireless network to a plurality of mobile devices comprising:
providing a service for collecting and storing account information related to the wireless network;
establishing by the service a plurality of guest relationships between the wireless network and the plurality of mobile devices;
receiving by the service a fee charged by the wireless network for the guest services provided to each of the plurality of mobile devices; and
automatically processing the fee for each of the plurality of mobile devices such that the wireless network is not required to collect payment from each of the plurality of mobile devices.

36. The method of claim 35, wherein processing the fee includes verifying at the time the services are provided that the fee charged corresponds accurately to the services provided.

37. The method of claim 35, wherein processing the fee includes totaling the fees charged during a predetermined time period and paying the wireless network for the total fee at the close of the predetermined time period.

38. The method of claim 37 further including requiring the wireless network to provide the account information, wherein the account information includes a financial institution associated with the wireless network.

39. The method of claim 38 further including automatically crediting the total fee to the financial institution after authorization from the network.

40. A guest services support system comprising:
a wireless network;
a device enabled to engage in wireless communications; and
a service coupled to the wireless network via a public network,
wherein a relationship between the service and the device is established so that the service can be utilized by the device to authorize a guest relationship between the device and the wireless network, thereby allowing the device to access the wireless network as a guest without requiring additional manual intervention from a user of the mobile device.

41. The system of claim 40 wherein the service establishes a relationship with the device by creating an account associated with the device and storing billing information and rules in the account.

42. The system of claim 41, wherein the rules are defined by the user and indicate how much money the user is willing to pay for services provided by the wireless network.

43. The system of claim 41, wherein the service authorizes the guest relationship between the device and the wireless network by comparing the rules with price parameters designated by the wireless network, and based on the comparison, determines whether any one of the rules is violated.

44. The system of claim 43, wherein the service authorizes the guest relationship if none of the rules is violated.

45. The system of claim 43, wherein the service denies authorization if any one of the rules is violated.

46. The system of claim 45, wherein if the user overrides the denial, the service authorizes the guest relationship.

47. The system of claim 40, wherein the service is also utilized to process a fee charged by the wireless network for the services provided to the mobile device.
